(19) United States
(12) Patent Application Publication
(10) Pub. No.: US 2017/0345079 A1
(43) Pub. Date: Nov. 30, 2017

(54) NETWORK OF SMART APPLIANCES

(71) Applicant: ACCENTURE GLOBAL SOLUTIONS LIMITED, Dublin (IE)

(72) Inventors: Trilok RANGAN, Bangalore (IN); Kaviyarasu BALAKRISHNAN, Post Bangalore (IN); Rubin George CHACKO, Pune (IN); Gaurav Kumar BARMAN, Kundalahalli (IN)

(73) Assignee: ACCENTURE GLOBAL SOLUTIONS LIMITED, Dublin (IE)

(21) Appl. No.: 15/590,854

(22) Filed: May 9, 2017

(30) Foreign Application Priority Data
May 31, 2016 (IN) 201641018690

(51) Int. Cl. G06Q 30/06; G06K 7/14; G06F 17/30

(52) U.S. Cl. CPC G06Q 30/0633; G06Q 30/0625; G06F 17/30864; G06K 7/1413

(57) ABSTRACT

Smart appliances, user devices and servers are networked to form a complete end-to-end automated platform wherein the appliances are monitored by a server. Push notifications generated by the smart appliances whenever products contained therein are likely to be exhausted soon are received by the server. The server updates a shopping list on a user device to identify the products as requiring replenishment in response to receiving the push notifications. The server also enables displaying a user interface on the user device that facilitates various interactions for the users of the platform such as identifying products for replenishment, posting feedback on products or making an enquiry regarding products.

### CROSS REFERENCE TO RELATED APPLICATIONS

The present application claims priority under 35 U.S.C. 119(a)-(d) to Indian application number 201641018690, having a filing date of May 31, 2016, the disclosure of which is hereby incorporated by reference in its entirety.

### BACKGROUND

The proliferation of broadband networks and lowering costs of electronic components lead to the evolution of the Internet of Things (IoT). IoT represents a concept where everyday objects such as appliances, vehicles, security devices and the like are connected to the internet and are able to exchange data. The data can be collected from various components of the everyday objects such as sensors, measuring instruments, actuators, software and the like. The data thus exchanged facilitates real-time analytics whereby the objects can be controlled or actions can be executed based on the exchanged data. Connecting everyday objects to the internet permits the objects to be something more than merely functional structures. IoT concepts lead to development of technologies such as driverless cars, smart home systems, and the like. For example, a car connected to the internet can monitor its speed data and adjust its speed according to a regulated speed limit. In addition to controlling systems in real-time, the enormous amount of data collected from systems implementing the IoT can be mined for determining long-term behavioral trends in systems and users who employ the systems.

### BRIEF DESCRIPTION OF DRAWINGS

Features of the present disclosure are illustrated by way of examples shown in the following figures. In the following figures, like numerals indicate like elements, in which:

FIG. 1 is a block diagram of an IOIT platform in accordance with some examples.

FIG. 2 is a block diagram showing the various components of the IOIT platform in accordance with one example.

FIG. 3 is a block diagram that shows the details of a product monitor in accordance with one example.

FIG. 4 is a block diagram that shows the details of a communicator in accordance with one example.

FIG. 5 is a flowchart that details a method of processing various types of inputs on the IOIT platform.

FIG. 6 is a flowchart that shows a method of generating a replenishment date for a staple product in accordance with one example.

FIG. 7 is a flowchart of a method that is executed when an action input for replenishment is received.

FIG. 8 is a flowchart of a method that is executed when an action input from a user provides feedback or comments on user groups.

FIG. 9 is a flowchart that details an example method which is executed when an action input corresponding to an enquiry or a search is received.

FIG. 10 is an example flowchart that enables providing dynamic coupons to users.

FIG. 11 is a flowchart that details an example method of accessing the dynamic coupons by the user.

FIG. 12 illustrates transmission of information regarding the user's intended purchases to an IOIT server.

FIG. 13 shows an illustration that depicts one example of providing information regarding the user's purchases to the IOIT server.

FIG. 14 shows an illustration of the user device displaying a log in screen on an IOIT UI.

FIG. 15 is an illustration of the shopping cart showing dynamic coupons used on the IOIT platform.

FIG. 16 shows an illustration of a leader board within the IOIT UI.

FIG. 17 is a figure that shows the details displayed in a user profile of the IOIT platform.

FIG. 18 shows a display of a chat group wherein different messages of the chat group are displayed on backgrounds indicative of the sentiments expressed in the message.

FIG. 19 shows the search results provided by the IOIT platform in response to a user query.

FIG. 20 shows various views that may be generated by the IOIT UI in accordance with some examples.

FIG. 21 shows a chat window wherein a user is in conversation with a chat bot.

FIGS. 22a and 22b respectively show a pie chart and a line graph mapping the sentiments expressed in user comments or feedback.

FIG. 23 illustrates a computer system that may be used to implement one or more of the IOIT server, the brand servers, the retail servers or a user device.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

An IOIT (Internet of Interactive Things) platform connects users to various smart appliances and businesses via a dynamically updateable IOIT user interface (UI) such as an ‘app’ or a web interface which is configured to record ‘end-to-end’ information from smart appliances regarding products of interest to the manufacturers of the products. An IOIT server which forms a part of the IOIT platform can receive information from the various smart appliances and provides the backend support for the IOIT UI that allows users to interact with the IOIT platform. The IOIT UI includes functionality for executing different tasks such as but not limited to, receiving information regarding products which the user may record under a respective user profile, identifying the products from the information and allowing the user to carry out various actions in relation to the products. The information can be received by the IOIT server automatically from the smart appliances that are communicatively coupled with the IOIT platform. In one example, the information can include a push notification from a smart appliance regarding the need for replenishing a product contained in the smart appliance that will soon be exhausted. In another example, the product information is received manually in the form of scanned data that is obtained from scanning a bar code or a QR code identifying a product or an product.

The IOIT UI enables the users to execute different actions with the product information such as but not limited to, making purchases or enquiries, providing feedback, discussing with other users or chat bots and the like. In an example, the IOIT UI allows the user to put one or more smart appliances such as smart containers on the IOIT platform so that the smart appliances are configured to receive and send data to the other elements of the IOIT platform. The information regarding smart appliances added by the user to the IOIT platform can be accessed via the user's profile on the IOIT platform. Whenever the sensors of the smart appliance or the smart container detect that the product therein is about to be exhausted, a push notification can be sent to the IOIT sever so that the product is automatically added to the user's shopping list. Prior to the users purchasing specific products, the IOIT UI is configured to receive information regarding the user's intended purchases, transmits the information to the IOIT server and servers of the relevant businesses and provides users with discounts, coupons or loyalty points whose value is calculated in real-time. The discounts or coupons can be applied during transactions completing the intended purchases.

The IOIT UI allows the users to record information regarding the intended purchases, for example, via a ‘marking’ process that allows scanning of particular products at home that need to be replenished or configuring smart appliances to send push notifications when the products contained therein are about to be exhausted. The products thus ‘marked’ are automatically added to a shopping list configured in the user's profile associated with the IOIT platform. The shopping list is dynamically updated each time the user scans a code or each time a push notification is received. The information regarding the marked products from the user profile can be transmitted to respective brands and relevant retailers.

In one example, the relevant businesses that receive information regarding the users' intended purchases can include one or more of servers associated with brands and retailers. A brand may be associated with products manufactured by a particular manufacturer under a particular name. A retailer sells products of a particular brand or from a plurality of brands. Retailers may include online retailers who sell products via websites and brick-and-mortar retailers who sell products via physical stores located at various geographical locations. The IOIT platform therefore enables brands and retailers to receive information regarding the user's intended purchases even prior to the user visiting a retailer's physical or online outlet. The users can therefore be uniquely identified and their brand and retail store loyalty may be rewarded with personalized discounts or coupons that can be targeted to the users' intended purchases. The coupons can appear in the IOIT UI displayed on a portable user device such as a smartphone or tablet so that the user may present the coupons at the checkout as the purchase transactions are conducted.

Upon completion of the purchases, the IOIT UI allows users to record information regarding their purchases and post them to user groups such as chat rooms or discussion boards with their feedback. Users' posts to the chat rooms may be processed to include sentiment information in real-time prior to posting it publicly to the chat rooms or the discussion boards. Messages may be classified as having positive sentiment, negative sentiment or as neutral messages. The background color of the messages may be set based on the sentiment classification. In an example, the sentiment associated with the users' posted messages may be transmitted to the brands and/or retailers which may respond to the sentiments expressed in the messages.

In an example, the IOIT platform may interface with a search engine that enables users to execute ‘single-select’ or ‘multi-select’ searches using product information. For example, if a user purchases a bottle of olive oil and scans the bar code with a user device, web search results including articles, messages posted to discussion boards, advertisements and the like which are related to olive oil may be retrieved for presentation to the user in a ‘single-select’ process. If the user scans a bottle of olive oil and a container of tomatoes, a web search may be conducted to retrieve results responsive to the information provided by the user. In an example, recipes with olive oil and tomatoes may be retrieved and presented to the user via the IOIT UI.

The chat rooms or discussion boards allow the users to interact with each other via exchanging text, audio and video messages. In addition, the IOIT platform incorporates chat bots for answering users' queries and collecting user feedback. The chat bot is capable of searching various internet-based sources to answer user queries in a question-answer (QA) session as if a person were answering the users' queries. Various discussion groups may be hosted by the IOIT server based on the products, areas of interest, location, specific brands and the like. In addition, the IOIT platform also incorporates communication interfaces such as SKYPE for one-on-one communications or selective group discussions. The chat bots on the IOIT platform may also participate with a user community on the chat groups or on the SKYPE discussions sessions. The IOIT platform may also include gamification elements which encourage users' participation with the IOIT platform activities. Greater participation by a user may lead to the user gaining higher points which in turn may reward the user in different ways.

The IOIT platform is also configured to transmit aggregated or individual user data, analytics, product sales information and the like to the various brands and retail stores in accordance with one example. An events processor receives information regarding the marking events, scans at a retail location, purchase transaction information and stores the event information in corresponding storages. The information from the events processor may be used in real-time brand analysis and for developing training data for AI (Artificial Intelligence) modules that carry out analysis of user and products information as will be detailed further herein.

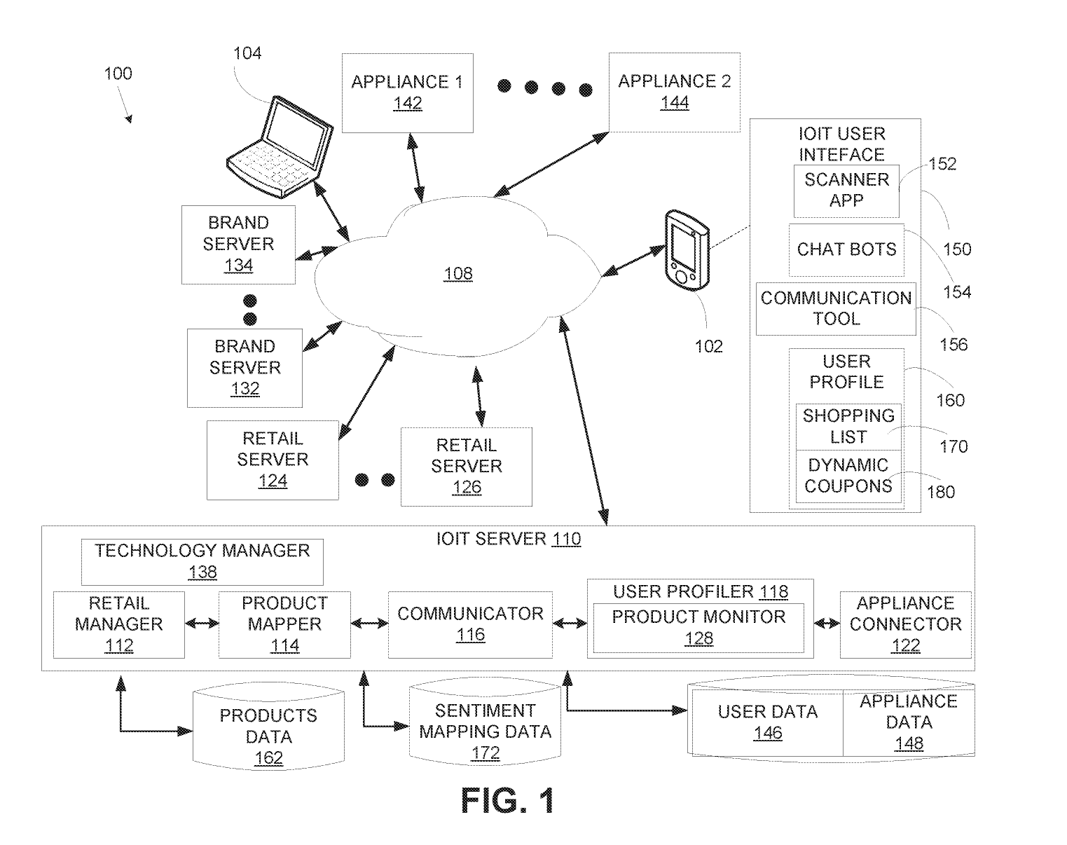

FIG. 1 is a block diagram of an IOIT platform 100 in accordance with some examples. The IOIT platform 100 includes a plurality of user devices 102, 104 connected to an IOIT server 110 via the internet 108. The IOIT server 110 is communicatively coupled to plurality of smart appliances 142, 144 via a network such as the internet 108. A technology manager 138 is hosted by the IOIT server 110 for facilitating the interactions between the user devices 102, 104 and the brand/retail servers 132, 134, 124 and 126. A smart appliance may include hardware that enables the appliance to be connected to a communication network such as the internet and exchange messages. As a result, the smart appliance can provide remote access to the data generated by hardware such as sensors which may be contained therein. In an example, the smart appliance would have an identifier such as an IP address which can be used to access and exchange messages therewith.

For each user registered on the IOIT platform 100, multiple smart appliances may be configured to send the push notifications for product replenishment within a user's profile 170. Accordingly, data for identifying the plurality of smart appliances 142, 144 such as IP address is stored in the appliance data 148 can be associated with the same user under a single user profile or may be associated with different user profiles. Therefore, users from a single household may each have the same appliance configured under their respective profiles so that when push notifications are sent to the IOIT server 110, they are forwarded to multiple user devices associated with multiple user profiles. For the sake of simplicity, it will be assumed that the plurality of appliances 142, 144 are associated with a single user profile. The user profiler 118 on the IOIT server 110 manages the multitude of profiles of users who may sign up for the services of the IOIT platform 100. In an example, a user profile 160 may include identification information of the user, device IDs of the user devices 102, 104, and the smart appliances 142, 144, location information, user preferences, demographic information and the like which are obtained from the users and stored in the user data 146.

In an example, the user devices 102, 104 can also receive information regarding the user's intended purchases via the user manually scanning the product codes using, for example, the scanner app 152 included in an IOIT UI (UI) 150. Containers having bar codes, QR codes and the like for perishables such as food products or non-perishable consumer products such as toothpaste or detergents which need to be replenished can be scanned for input by the scanner app 152 or any other scanner app that may be installed on the user device 102. The scan data from the user device 102 is transmitted to the IOIT sever 110. The IOIT server 110 in turn accesses a mapping of the scanned code to a respective product ID from the products data 162. The product ID which may include a generic identification or a brand name of a product, depending on the scanned code, can be automatically added to the shopping list 170.

In an example, the smart appliances 142, 144 may be connected to the IOIT platform 100 via the appliance connector 122 on the IOIT server 110. Each of the smart appliances 142, 144 may put forth proprietary application programming interfaces (APIs) for interacting therewith. The appliance connector 122 facilitates receiving the push notifications from the smart appliances 142, 144 by the IOIT server 110 whenever sensors in the smart appliances 142, 144 sense that the products contained therein are about to be exhausted and need to be replenished. The sensors may include weight sensors, level sensors, moisture sensors, heat sensors and the like. In other examples, the sensors may include those that send signals indicative of malfunctioning hardware. For example, smart home systems include lighting hardware capable of checking its functional state periodically such as every fortnight and displaying the result on a user interface. The IOIT UI 150 can be configured to receive the information and add an entry for a smart bulb into the user's shopping list 170. A product mapper 114 on the IOIT server 110 may map the scanned information or the data from the smart appliances 142, 144 to identify specific products to be added to the shopping list 170.

A user profiler 118 executed by the IOIT server 110 manages the user data 146 collected by the IOIT platform 100. Whenever a user signs up to access IOIT platform services, the information supplied by the user is stored under the user profile 160 by the user profiler 118. Edits or deletion of the user data 146 are also facilitated by the user profiler 118. Moreover, users' habits regarding products of interest may be recorded within the user profile 160 by the user profiler 118 and monitored by a product monitor 128 to deduce when the user may be in need of a particular product. For example, based on the user's purchases of shampoos over time, a pattern of the shampoo purchases may be identified from the user profile 160. When a user purchases a shampoo, the product monitor may use the pattern to extrapolate a date when the user's latest purchase of shampoo may be exhausted. In an example, the product code of the product may provide product attributes that aid in the projections. For example, the product code scanned from the shampoo container may indicate the amount of shampoo purchased which may in turn be used to project a date when the shampoo is exhausted.

A push notification may be sent to the IOIT UI 150 by the user profiler 118 to remind the user to check for shampoo, for example, via automatically adding it to the user's shopping list in the IOIT UI 150. It may be appreciated that IOIT platform 100 is built for cross platform compatibility and therefore, the IOIT UI 150 is accessible by the plurality of user devices 102, 104 that the user may register under the user profile 160. While one user device 104 is used for receiving input regarding the intended purchases for the user profile 160 on the IOIT UI 150, another user device 102 may be used at a brick-and-mortar store to complete the purchase transactions on the same user profile 160 by accessing the IOIT UI 150 via the user device 102.

Products which are scanned can be ‘marked’ for purchase and may be moved up the shopping list 170 included in the user profile 160. Each time an product from the shopping list 170 is marked for purchase, the information regarding the product is transmitted to one or more of the brand severs 132, 134 and retail servers 124, 126. Based on various criteria, the retailers or brands may offer discounts or coupons for the product to the user. At the time of purchase, when the user adds the products to be purchased to an online shopping cart, the information regarding the products may be transmitted by the retail manager 112 to one or more of the brand servers 132, 134 and the retail servers 124, 126. In the case of a brick-and-mortar retail store, the products in the user's physical shopping cart may be scanned at the point of sale and their data may be obtained as information of the products intended for purchase.

In an example, access to the IOIT server(s) 110 can be provided as a cloud service to which the various brands and retailers may connect for receiving IOIT services described herein. The user associated with the user device 102 is thus uniquely identified by the user profiler 118 and his/her information available with the brand and/or the retailer is retrieved to determine if any discounts or coupons can be made available to the user. If there are discounts or other deals available to the user, the brand and/or the retail servers respond to the IOIT server 110 with the value(s) of the available discounts, coupons, deals and the like. The IOIT server 110 updates the dynamic coupons 180 included in the user's profile 160 of the IOIT UI 150 at the time of purchase. The user can apply the dynamically updated coupons 180 for purchasing the products in the shopping cart. The user is therefore able to receive dynamic coupons 180 personalized to his/her shopping needs. The brands associated with the brand servers 132, 134 are able to individually identify users who are loyal to their brands, frequency of their purchases, the users' shopping habits and the like across the various retailers. The retailers in turn are able to track users' purchases well ahead of the actual purchase transactions, the users who frequent their locations, the brands they use, their shopping habits and the like.

The IOIT platform 100 provides various interactions to the users even subsequent to the shopping trip as part of the gamification. Each user interaction on the IOIT platform 100 can account for a certain number of points being added to the user's account wherein different interactions may result in addition of different points. The interactions may include but are not limited to signing up for the IOIT services, putting smart appliances 142, 144 and user devices 102, 104 on the IOIT platform 100, maintaining and updating the shopping list 170 regularly, using the

IOIT platform 100 routinely for shopping needs, providing feedback regarding one or more of products, retailers, brands and the like, answering other users' queries, and using chat groups or voice/video sessions such as SKYPE sessions for gathering information. Greater user interaction therefore results in more points being added to the user account. In return for the interactions, the user may be rewarded with discounts, special offers, coupons, recognition of the user among the user communities and the like.

In an example, as the user begins to use the purchased products, he/she may provide feedback via posting messages, images, videos and the like to chat groups accessible from the IOIT UI 150. The user's feedback is received by the IOIT server 110 which analyzes the sentiments associated with the feedback and the message that is displayed in the chat group may be color coded to reflect its sentiment based, for example, on a sentiment mapping data 172 which may store a mapping from the colors to be used for the various sentiments. By the way of illustration, based on whether the message is classified as a positive message, a negative message or a neutral message, it may be displayed on various colored backgrounds. Users may also seek additional information from the IOIT server 110 regarding various products. The IOIT UI 150 may include chat bots 154 that can be employed to answer user queries. Chat bots 154 are programmatic entities that mimic or simulate conversations like human users via text or auditory methods. The IOIT UI 150 may facilitate the user access to multiple chat bots associated with the various products. The chat bots 154 may be integrated into user chat groups in one example where the chat bot participates in the group discussions like other human users. The chat bots 154 may also be accessed via communication tools 156 such as SKYPE for one-on-one interactions by the users. In addition, the IOIT server 110 updates the relevant brand and/or retailer regarding the user's message. The brand and/or the retailer may respond based on the sentiment associated with the message. If a positive sentiment is expressed in the message, an action such as providing loyalty points to the user and the like may be executed. If a negative sentiment is expressed in the message, a refund or other remedial action may be offered.

The IOIT platform 100 also facilitates a ‘single select’ and/or ‘multi-select’ operations to be executed by the users via the IOIT UI 150. If the user enters information regarding a product, via scanning its barcode for example, a search with the product name as the query may be initiated and the query results may be displayed on the IOIT UI 150. Similarly a ‘multi-select’ operation enables a search with a search query that includes a plurality of product names corresponding to the plurality of scanned product codes. During a scanning operation, the product mapper 114 may retrieve the product or product ID from the products data 162 and supply it to the search engine as a keyword. In an example, the multi-select operation may use an ‘and’ operator between the various keywords in order to conduct the search.

The query results may not only include results gained from an internet search engine but also the results from the various chat groups associated with the

IOIT platform 100. In an example, the chat groups associated with the IOIT platform 100 may be private chat groups available only to the users of the IOIT platform 100 and are not accessible via the internet. Accordingly, the search results may include publicly available data and private data. For example, the user may scan identifying indicia of a plurality of edible products and recipes based on one or more of the edible products may be displayed in the IOIT UI 150. Similarly, if the identifying indicia of a few hardware pieces are scanned, then assembly instructions for a furniture product assembled from the hardware pieces may be displayed.

In view of the rich user-product information available to the IOIT server 110, different analytics for the various brand and retail servers 132, 134, 124 and 126. Besides providing information regarding users' individual shopping habits, the IOIT server 110 also provides real-time brand analysis. For example, when the sentiments of various user posts associated with different products are derived, the brands and/or retailers associated with the products may be informed of the user sentiments. The real-time sentimental analysis may be significant especially for newly launched products. If a newly-launched product generates a flurry of messages with positive sentiments, it can be derived that the newly-launched product is being purchased and well received by the users. However, if a newly-launched product fails to generate any buzz (messages), it can be derived that further marketing is required. The user feedback provided to brands and/or retailers in real-time may thus enable them to monitor product launches and take corrective actions if needed.

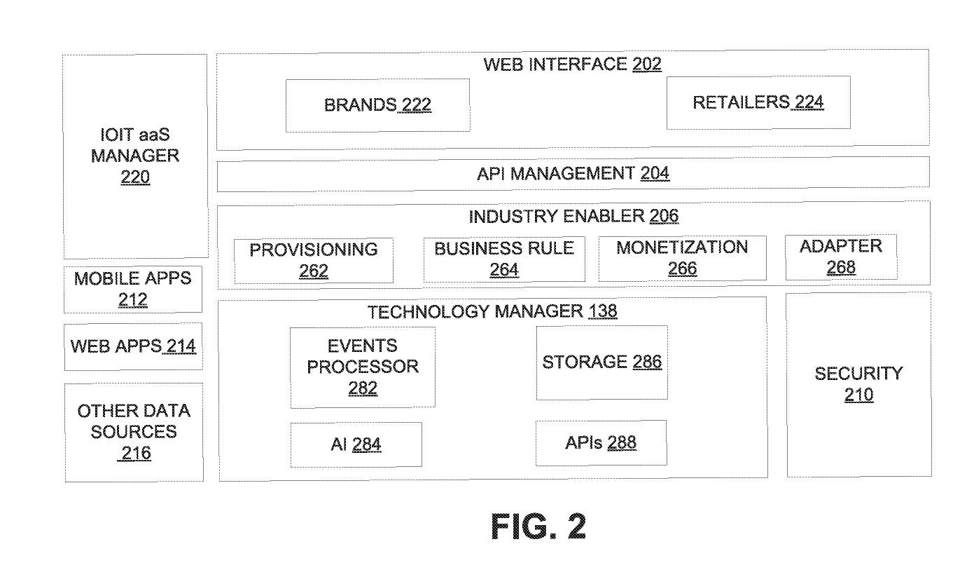

FIG. 2 is a block diagram showing the various components of the IOIT platform 100 in accordance with one example. A web interface 202 connects brands 222 and retailers 224 (via the brand servers 132, 134 and retail servers 124, 126) to an adapter 268 via API management layer 204. The adapter 268 enables connecting the brand servers 132, 134 and retail servers 124, 126 to the IOIT server(s) 110 via their respective API (Application Programming Interfaces). The IOIT server 110 therefore may use the respective API exposed by each of the brand servers 132, 134 and each of the retail servers 124, 126 for establishing connections thereto. This enables the brands 222 and retailers 224 to establish their custom dashboards and interfaces. The API management layer 204 interfaces with the industry enabler 206 which may include provisioning of various systems 262 for implementing the IOIT platform which may include establishing the business rules 264 and monetization processes 266.

The technology manager 138 is hosted by the IOIT server 110 for facilitating the interactions between the user devices 102, 104 and the brand/retail servers 132, 134, 124 and 126. In an example, the technology manager 208 may be a C#, .NET based stack. An events processor 282 receives the various events generated by the user devices 102, 104 during the marking process when products are identified for intended purchase, during the purchase process when the user associated with the user device 102 uses the dynamic coupons for purchases and during the feedback process when the user provides feedback regarding the purchases and other events which may be generated during the interactions of the user with the IOIT UI 150. The information regarding the various events are saved to the storage 286 for use in real-time brand analysis by the various APIs and for training purposes by the Al components 284. The Al components 284 may use trained classifiers that use supervised or unsupervised learning to analyze data and provide trends to the users, brands and retailers. For the users, they may be used to predict when certain products will need replenishing based on the date of purchase and the usage patterns recorded in the user profiles, product recommendations based, for example on currently purchased products, deals and the like. In an example, the storage 286 may store business analytics instructions to analyze event data and provide appropriate intelligence to the brands and retailers.

As mentioned above, APIs 288 are used for executing various functions associated with the IOIT platform 100. For example, user feedback is analyzed in real-time using sentiment analysis APIs such as sentiment dynamics APIs so that negative or positive feedback can receive responses as determined by the business rules 264. Similarly custom REST JSON (Representational State Transfer JavaScript Object Notation) API can be used for shopping lists and other mobile interactions. The security layer 210 enforces security for the various components within the IOIT platform. Mobile apps 212, web apps 214 and other data sources 216 are the sources of events for the events processor 282. Examples of other data sources can include IOIT aaS manager 220 manages the industry enabler 206 and the technology manager 138.

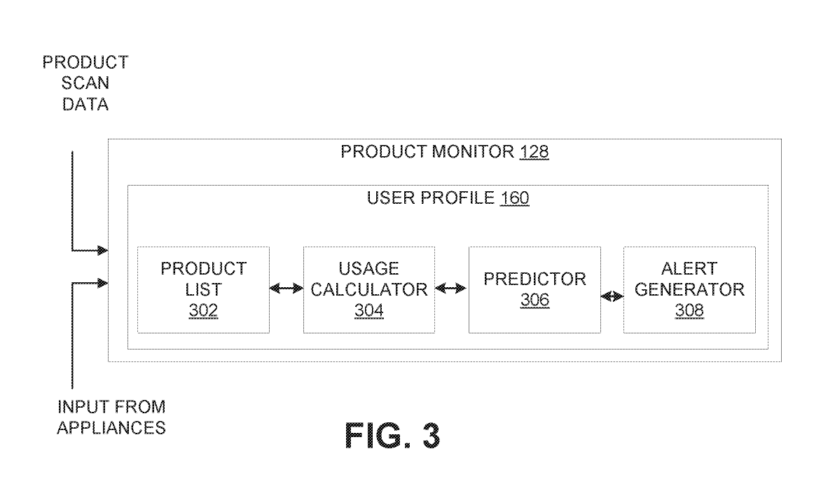

FIG. 3 is a block diagram that shows the details of the product monitor 128 in accordance with one example. The product monitor 128 includes for each user profile 160, a product list 302, a usage calculator 304, a predictor 306 and an alert generator 308. In an example, the contents of the product list 302 may be identical to the shopping list 170. In an example, the product list 302 contents may be different from the shopping list 170 as the product list 302 includes products being monitored for usage while the shopping list 170 may include products that the user intends to purchase in the near future. For example, the shopping list 170 can be viewed and/or edited by a user, and may include for example the top ten products in terms of exhaustion dates. On the other hand, the product list 302 may include all the products purchased by the user within a certain preceding time period, for example, six months or one year. Also, the product list 302 may be an internal data structure of the IOIT sever 110 which may be accessible to the user, for example, via user profile settings of the IOIT UI 150. However, the product list 302 may also be indirectly edited by a user when the user elects to discontinue use of a product. The product may be explicitly deleted by the user from the shopping list 170 or the user may stop purchasing the product. When the user discontinues the use of a product and does not purchase is for a certain predetermined time period, the product monitor 128 may be configured to delete is from the products list 302.

When the user associated with the user profile 160 initially enters the products to be monitored for usage, they are arranged in the products list 302. New products may be explicitly added by the user either via keying in the product IDs, scanning the bar codes or QR codes or configuring the smart appliances 142 and 144 to push notifications to the IOIT server 110 when the corresponding products are about to be exhausted. New products may also be automatically added when the user purchases a product. In case the user does not wish the usage of a product to be monitored, the user can delete the product from the product list 302 via a widget on the IOIT UI 150.

When a product is newly added to the product list 302, the usage calculator 304 may set an initial replenishment date based, for example, on an average of all the users of the product on IOIT platform 100. As the user continues to employ the IOIT platform 100, the user profile 160 receives inputs such as push notifications from the smart appliances 142, 144 and product scan data explicitly provided by the user when purchasing products. The initial replenishment date may either be confirmed or adjusted based on the date of receipt of an initial replenishment input. The usage calculator 304 records such inputs over time and obtains a rate of usage of the product that is unique to the user profile 160. With the passage of time and continued usage of the IOIT platform 100, the results from the usage calculator 304 are fed to the predictor 306 which can employ Al techniques to learn the unique rate of usage of the product associated with the user profile 160. Accordingly, the predictor 306 can estimate when a product from the product list 302 will soon be exhausted. For example, based on the usage of the product over a time period, the predictor 306 may determine a threshold level for the product. When the product falls below the threshold level, the predictor 308 can cause the alert generator 308 to show an alert on the IOIT UI 150. In an example, the predictor 306 can maintain a countdown that constantly shows the product level and signals the user to buy the product with specific color code when the predictor 306 determines that the product is below the threshold level. The threshold level may be conveyed via a quantity in an example. The threshold level may also be conveyed via a time period until the product is exhausted, wherein the time period is calculated based on the user's rate of usage of the product.

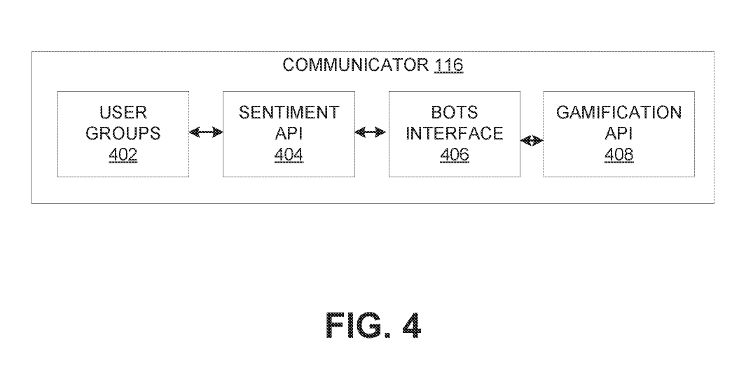

FIG. 4 is a block diagram that shows the details of the communicator 116 in accordance with one example. The communicator 116 may include the user groups 402 that are formed based on various criteria. For example, user groups may be based on products, geographical locations, demographic criteria or other criteria that may be identified by an administrators or users of the IOIT server 110. In an example, users may form their own family or friends groups on the IOIT server 110. The user groups enable users to make connections with other users of similar interests and exchange information. A user may search through existing user groups via the IOIT UI 150 to identify those groups which the user would like to join.

Various messages such as textual, audio or video messages may be posted in the user groups. In an example, the textual messages may be processed by the sentiment API 404 to identify the sentiments expressed in the message towards a product, a concept or other entity. The sentiment in a user's comments can be identified via normalizing the text and associating specific colors for each of the positive, negative or neutral sentiments. In an example, the sentiment API 404 may provide access to a data store that maps particular sentiments to specific colors. The intensity of the sentiments may also be indicated via corresponding intensity of the background color. For example, the colors may vary from intense green to lighter green to indicate positive sentiment, white for neutral sentiment or no sentiment such as for messages delivering factual information and lighter red to deep red indicating mildly negative to highly negative sentiments.

The bots interface 406 may support various chat bots for participating in group or one-on-one conversations with users. The chat bots may be native to the IOIT platform 100 or they may be provided by one or more of the retailers or brands. When participating in groups, an administrator may include a relevant chat bot as a member of the group. For example, a user group associated with a product may have within its members a chat bot provided by the brand for answering users' queries and collecting user sentiments regarding the product. A user may also be able to conduct an individual chat with a chat bot via communication tools such as SKYPE. In an example, the communication tool 156 may be included in the IOIT UI 150. In an example, the communication tool 156 may lie outside the IOIT UI 150 as a separate app on the user device 102. In the later example, the IOIT UI 150 is configured with the API of the communication tool 156 to facilitate textual or audio/video interactions with other users of the IOIT platform 100 or chat bots. The communicator 116 also includes gamification API 408 such as, Playlyfe, for implementing elements such as leader board for each user group, total points accumulated by each user, points accumulated by a user for each interaction which may include purchases, feedback, conversations with other users, and the like.

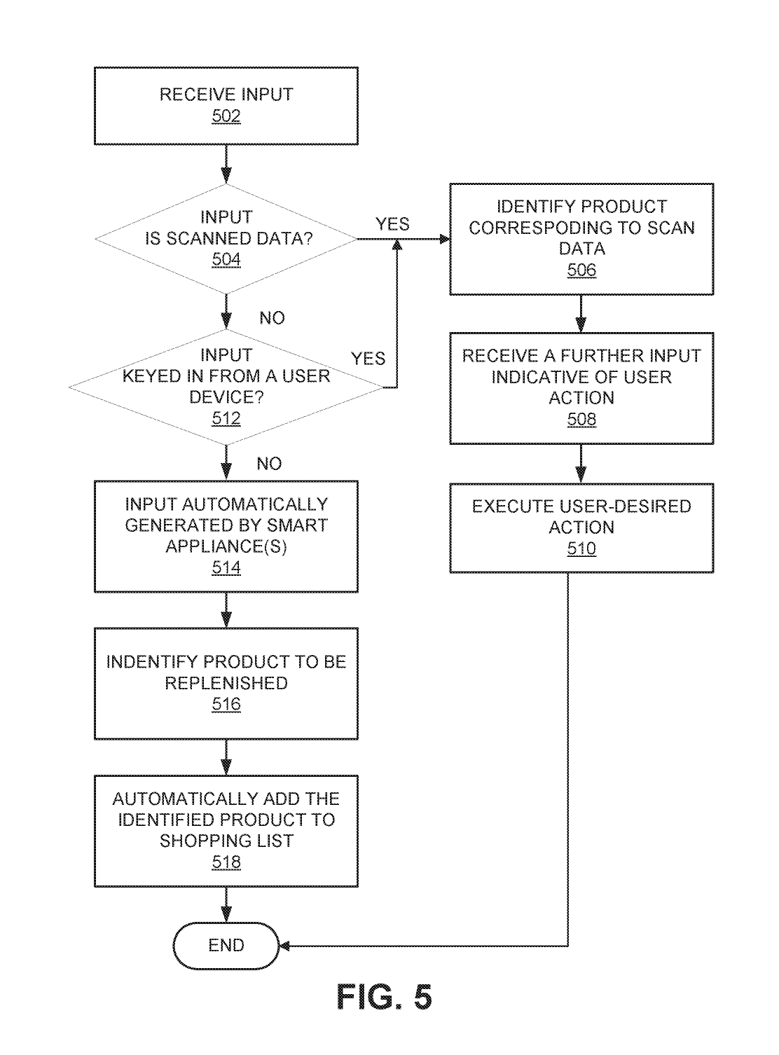

FIG. 5 is a flowchart 500 that details a method of processing various types of inputs on the IOIT platform 100. The method begins at 502 with the IOIT server 110 receiving an input associated with a product of interest to the user in one of the various forms such as but not limited to coded data from a scanner, keyed input from a user device or automatic input from one of the smart appliances 142, 144. Different forms of input may signify different actions desired by the user and accordingly, the inputs may be processed in different ways. While the processing of inputs will be discussed serially herein, it may be appreciated that the order of processing or testing for inputs is discussed for illustration purposes only. Initially the IOIT server 110 may determine at 504 if the received input is coded data received from a scanner which scans a bar code or a QR code. The scanner data may be received from a product scanner such as those found at retail establishments or the scanner data may be received from the scanning app 152 or other scanning software included within one of the user devices 102, 104. If it is determined at 504 that the received input is scanner data, the method moves to 506 to identify the product associated with the scanner data. The product may be identified via accessing a data mapping that maps specific bar codes or QR codes to their corresponding products. At 508, a further input is received which is indicative of an action the user would like to have executed by the IOIT server 110. The actions may include adding the product to shopping list for replenishment, posting feedback, making an enquiry or conducting a search and the like. The action corresponding to the received input is executed at 510 as described herein.

If it is determined at 504 that the input received is not scanner data, the method proceeds to 512 to determine if the received input is keyed in by the user from one of the user devices 102, 104. If it is determined at 512 that the input was keyed in from one of the user devices 102, 104, the method again proceeds to 506 to identify the product and then to 508 to receive input regarding an action the user would like to have execute by the IOIT server 110. If it is determined at 512 that the input was not keyed in either, it is determined at 514 that the input is automatically generated push notification transmitted by one or more of the smart appliances 142, 144. The input from the smart appliances 142, 144 pertains to replenishment of a product which is soon to be exhausted. Accordingly at 516, the product to be replenished is identified and automatically added to the shopping list 170 at 518.

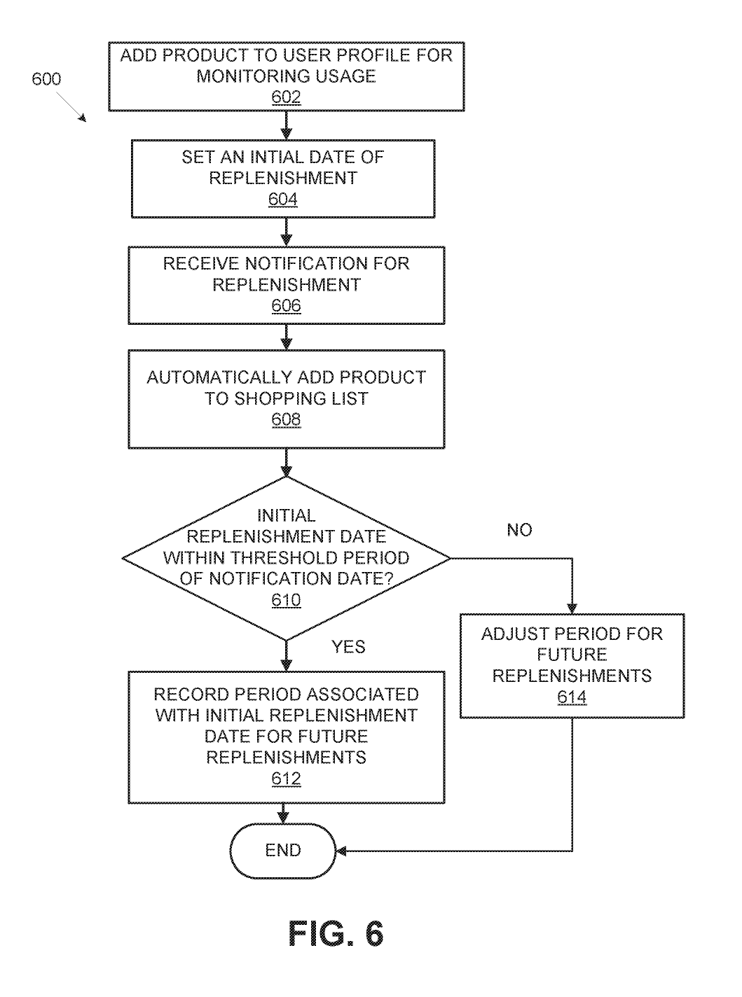

FIG. 6 is a flowchart 600 that shows a method of generating a replenishment date for a staple product added to a user's shopping list 170 in accordance with one example. The method begins at 602 wherein a product is initially added to a user's profile for monitoring usage and automatically adding to the shopping list which includes a user's intended purchases. At 604, an initial date for replenishment may be set, for example, based on the global usage rate for the product across the IOIT 100 platform. The global usage rate may be the average rate associated with all the users of the product on the IOIT platform 100. In other examples, the initial date may be set based on the local, demographic or other usage rates available for the product. At 606, a notification regarding replenishment is received and the product is automatically added to the shopping list 170 at 608. The notification may be a push notification sent to the IOIT server 110 by one or more of the smart appliances 142 or 144. The notification my also include scanned data received, for example, from the user devices 102 and 104 wherein a user scans the barcode or QR code or keys in the product id, such as the product name or brand name and provides an action input for replenishment.

At 610, it is determined if the initial date for replenishment is comparable or close to the date on which the notification regarding replenishment is received. For example, if the initial replenishment date is within a threshold time period of the notification date, then the initial replenishment date is confirmed as accurate. A period from the date of addition of the product to the shopping list 170 till the initial replenishment date is recorded as replenishment period for future replenishments at 612. Accordingly, upon elapsing of another replenishment period, an alert may be popped up on the IOIT UI 150 or the product may be automatically added to the shopping list 170 as an intended purchase. If it is determined at 610 that the initial replenishment date is inaccurate compared with the notification date, the replenishment period may be adjusted at 614 by bringing forward or moving back the initial replenishment date to coincide with the notification date. As the IOIT platform 100 is employed over time, the usage data of the product may be stored in the user profile 160 which in turn can be used to make accurate predictions regarding usage as more data is gathered over time which facilitates training the predictor 306 to make more accurate predictions.

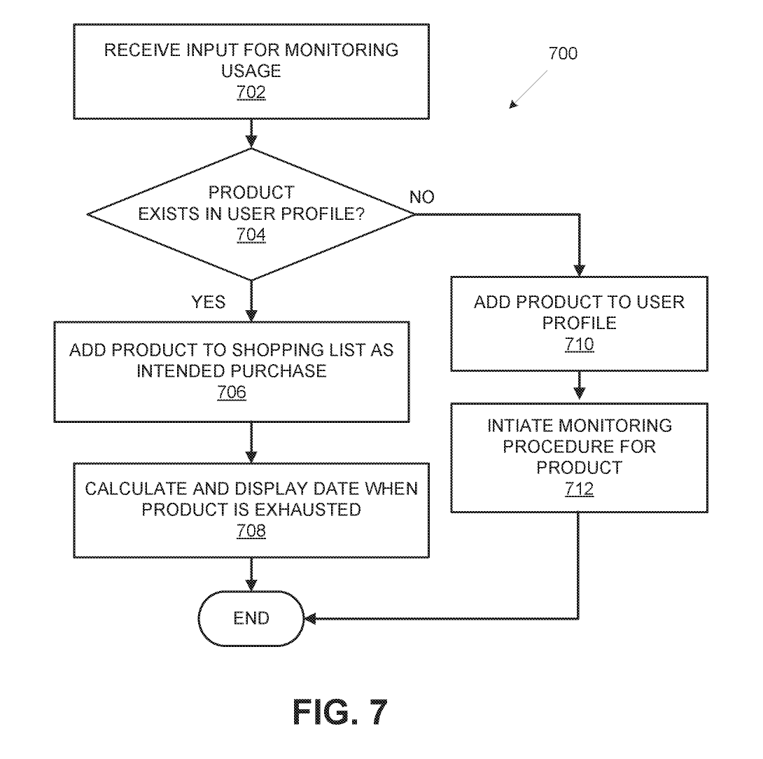

FIG. 7 is a flowchart 700 of a method that is executed when an action input from the user upon receiving a product information is an input for replenishment. The method begins at 702 wherein an action input for replenishment is initially received. As mentioned herein, the action input for replenishment may be transmitted manually by a user or automatically by one of the smart appliances 142 or 144. At 704 it is determined if the product associated with the replenishment action input already exists in the user profile 160. In an example, the product ID obtained from the products data 162 is matched with the product information stored in the user profile 160 to determine the presence of matching or relevant keywords. If it is determined at 704 via a matching product ID or relevant keyword, that the product already exists in the user profile 160, the product is marked as requiring replenishing at 706 by adding it as an intended purchase to the shopping list 170. In addition, the number of days until the product is completely exhausted may be calculated and displayed to the user on the IOIT UI 150 at 708. If it is determined at 704 that the product does not exist in the user profile 160, the product is added to the user profile at 710 and the IOIT server 110 initiates a monitoring procedure for the product at 712. The initiation of a monitoring procedure may involve setting an initial replenishment date and determining a period for replenishment as described herein.

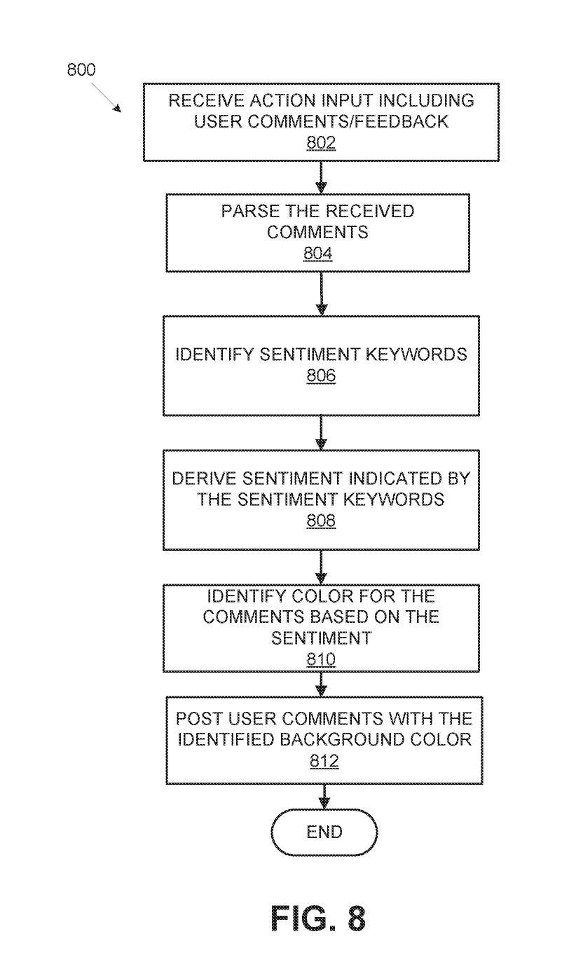

FIG. 8 is a flowchart 800 of an example method that is executed when an action input from a user provides feedback or comments on user groups within the IOIT platform 100. The method begins at 802 wherein action input including user feedback or comments is received from a user for posting to a user group. At 804, the received comments are parsed to identify words or tokens. At 806, sentiment keywords which are words indicative of sentiments are identified from the tokens. A classifier may be trained to pick out sentiment keywords from the tokens obtained by parsing the user's comments/feedback. For example, words such as “good”, “great”, ‘like”, “will recommend”, “thanks” and the like express positive sentiments, while words such as “bad”, “worst” and the like may indicate negative sentiments. Comments may also include those which are neutral and do not express any sentiments. For example, responses posted by a chat bot to a user query may be classified as a neutral comment. A sentiment associated with the sentiment keywords is derived at 808. Application programming interfaces (APIs) for analysis of sentiments such as Sentiment Dynamics may be utilized to determine if the user's comments have positive, negative or neutral opinion polarity. The IOIT server 110 is configured to display a user comment or feedback within a message board on a background indicative of its sentiment. The IOIT server 110 may store a mapping of sentiment keywords and colors in the sentiment mapping data 172 so that when specific sentiment keywords indicative of a particular are identified within the user comment, the user comment is displayed in a correspondingly colored background. The sentiment analysis of user comments is completed prior to posting the comments in the user discussion board. Accordingly, at 810, a background color for the user comments is identified from the sentiment mapping data 172. The user comments are posted on the identified background color within the user group at 812. Processing user comments for sentiments and displaying the user comments on specific background colors aids the user in identifying a general sentiment of a user group at a glance without having to read the user comments in detail.

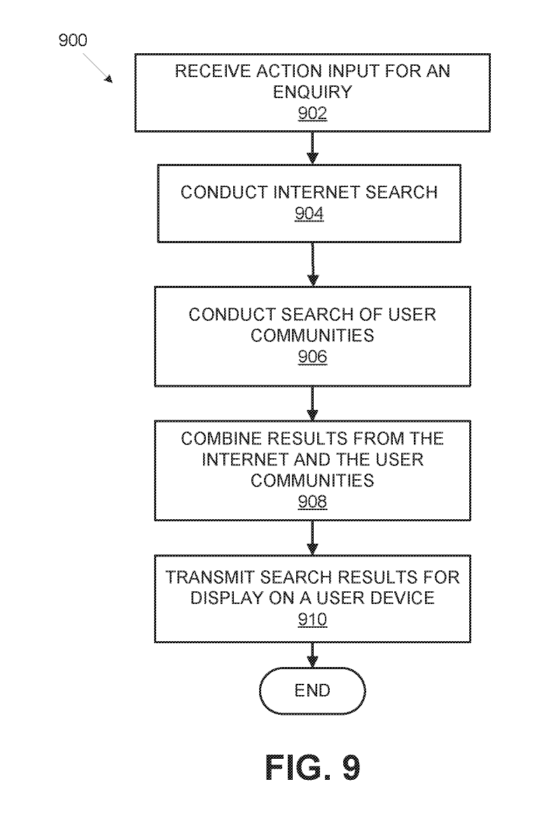

FIG. 9 is a flowchart 900 that details an example method which is executed when an action input corresponding to an enquiry, request for information or a search is received. The method commences at 902 wherein an action input for a search or enquiry is received. The action input for a search may be received via one or more of keywords typed in by the user into a browser integrated with the IOIT UI 150 or via scanned data wherein one or more bar codes or QR codes of one or more products are manually scanned. The search input may correspond to a single search wherein a one or more keywords corresponding to a single product or single concept is provided. The search input may also correspond to a multi search wherein multiple keywords and/or scan data corresponding to multiple products or multiple concepts are received. The IOIT server 110 is configured to identify search results that are not merely relevant to the multiple keywords but connect the multiple keywords in a meaningful way. For example, if multiple barcodes corresponding to different parts of a furniture piece are received, the IOIT server 110 can retrieve assembly instructions for the furniture piece.

At 904, an internet search is conducted with the one or more keywords obtained from the input at 902. At 906, a search of the user groups or communities on the IOIT platform 100 is also conducted. If multiple keywords are used, the results from the internet search at 904 and the user groups search at 906 that meaningfully combine the keywords are selected at 908. In an example, the IOIT server 110 may prioritize search results from the user groups over the internet search results. At 910, the search results are transmitted for display on a user device. In an example, search results may also include a link that enables the user to have a conversation with a chat bot relevant to the keywords so that the user is provided additional assistance in case the user is not satisfied with the search results.

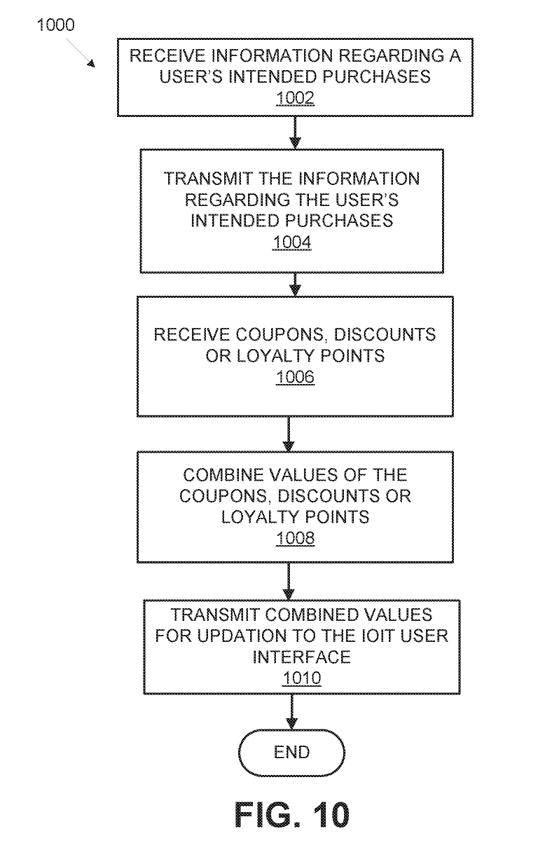

FIG. 10 is an example flowchart 1000 that enables providing dynamic coupons to users. The method may be implemented by the IOIT server 110 in an example. The method begins with receiving information regarding products that a user intends to purchase from the user's shopping list 170 at 1002. At 1004, the information regarding the users intended purchases is transmitted to the respective relevant businesses. For example, if the user specifies a brand associated with a product, the information may be transmitted to the brand server 132 or 134 associated with the user specified brand. In another example, the information regarding the user's specified brand may be transmitted to all the brands associated with the IOIT server 110. Similarly, if the user's preferred retailer is known, the information regarding the user's intended purchases may be transmitted to the retailer. Else retailers within a predetermined radius of the user's location may be selected for transmitting the information regarding the user's intended purchases.

At 1006, the information regarding one or more of the discounts, deals, loyalty points, coupons and the like that the brands and/or retailers are offering are received from a plurality of disparate data sources such as one or more of the brand servers 132, 134 or retail servers 124, 126. In an example, the deals, discounts or coupon values can be calculated dynamically via applying machine learning to user data such as usage/shopping patterns of the user. The discounts or coupon values or loyalty points may be based on the user's brand loyalty in an example. At 1008, the received information from the various deals, discounts, or loyalty points from the various businesses are combined. Loyalty points a brand offers for different products may be combined in one example. Discounts offered by a retailer and a brand for a particular product or product may be combined in another example. In an example, the coupon values may be further based on the user interaction with the IOIT platform. Greater user interaction with the IOIT platform may lead to higher discounts, better deals or more loyalty points. The combined values are transmitted at 1010 to be dynamically updated to the IOIT UI 150 executing on the user device 102.

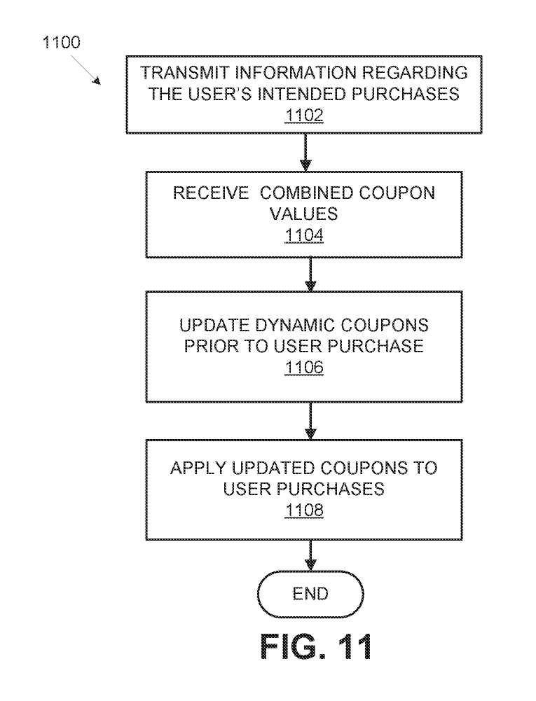

FIG. 11 is a flowchart 1100 that details an example method of providing access to the dynamically updateable coupons to the user. The method may be implemented by the user device 102 in an example. The method begins at 1102 with the user device 102 transmitting the information regarding the user's intended purchases included in the shopping list 170 to the IOIT server 110. The information may be received into the shopping list 170 either via explicit user input, via scanning of product codes which may include bar codes, QR codes or other identification indicia or via reception from smart appliances 142, 144 or smart containers that transmit notifications/messages when the products contained therein need to be replenished. At 1104, the combined values to be applied to the dynamic coupons on the IOIT UI 150 are received from the IOIT server 110. Accordingly, the dynamic coupons 180 are updated under the user profile 160 so that they are accessible to the user via the IOIT UI 150 at 1106 prior to the user's actual purchases. At 1108, the updated dynamic coupons are applied to the purchase transactions for the products associated with the user's intended purchases.

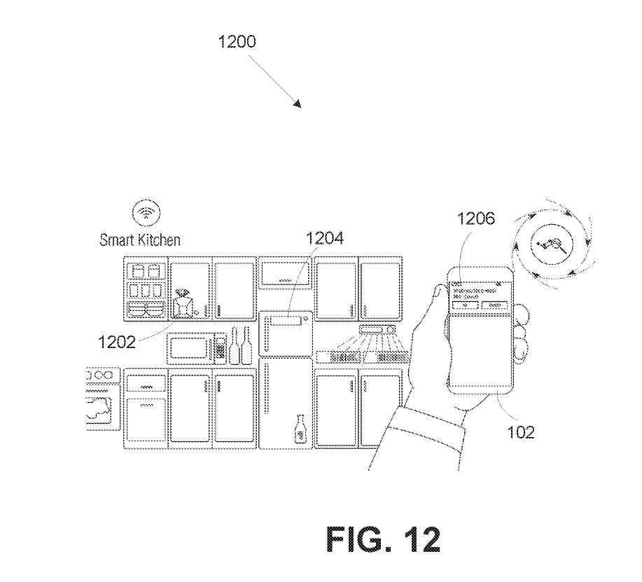

FIG. 12 illustrates transmission of information regarding the user's intended purchases to the IOIT server 110. The products 1202 and 1204 are marked as requiring replenishing. Based on the dates of purchase and usage patterns, the IOIT server 110 estimates when certain staple products may run out and provides push notifications to the user when it is time for replenishment of the products. In an example, the user may be provided with options regarding the push notifications while configuring his/her profile with the IOIT platform 100. If the user opts to receive the push notifications, the refrigerator 1204 and a smart container 1202 which stores bread can transmit push notifications to the IOIT server 110 when the products container therein go below respective predetermined thresholds. The refrigerator 1204 may have a level sensor or a weight sensor so that when the milk level or weight goes below a predetermined weight or level threshold programmed into the sensor, a notification is automatically pushed to the user device 102. Similarly, a weight sensor on the container 1202 may transmit a push notification when the bread therein goes below a predetermined weight threshold. The IOIT UI 150 being executed by the user device 102 may pop up an alert 1206 to the user if he/she would like to mark milk for replenishment. The alert 1206 may include standard ‘OK’ and ‘Cancel’ buttons wherein if the user presses the ‘OK’ button, milk is designated for replenishment. If the ‘Cancel’ button is pressed, the push notification may be ignored in the current instance. However, it may be noted that the IOIT server 110 will continue to receive the push notifications unless the refrigerator 1204 is disabled from sending the push notifications to the IOIT server 110.

When the IOIT server 110 designates the products as requiring replenishment, the products are marked in red on the IOIT UI 150 and moved up the shopping list 170. Therefore, at any given time, the shopping list 170 may be dynamically adjusted to display products, for example, in an ascending order of days to exhaustion wherein an product with the earliest date to exhaustion being displayed first. In addition, number of days for the product to run out is shown in a dynamic counter so that the number of days displayed on the IOIT UI 150 is decremented with each passing day until the product is purchased or the counter reaches zero.

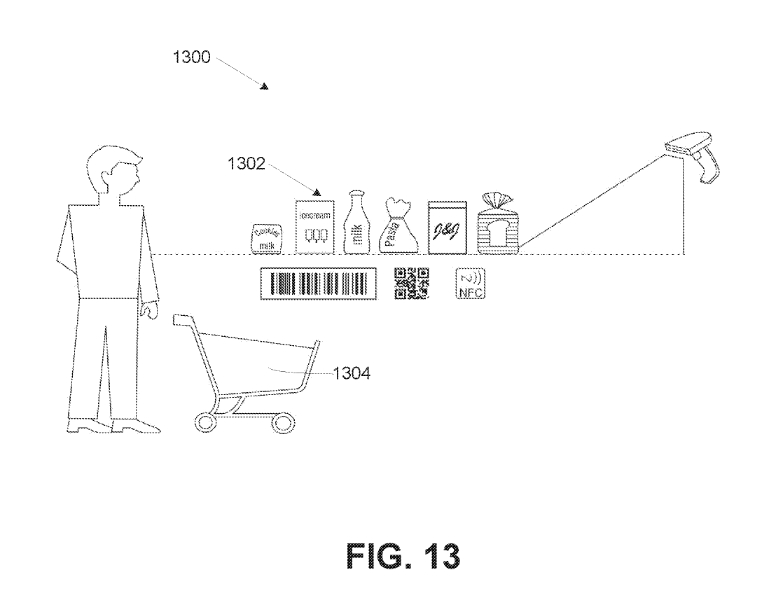

FIG. 13 is an illustration 1300 that depicts one example of providing information regarding the user's purchases to the IOIT server 110. Based on the products in the shopping list 170, the user may add products to the physical shopping cart 1304. As the products 1302 in the user's physical shopping cart 1304 are scanned at the point of sale, the information regarding the user's purchases may be transmitted to the IOIT server 110. Attributes of the purchase transactions such as dates, amounts, brands, retail locations or outlets, modes of payments and the like may be recorded by the IOIT server 110 under the user profile 160. Various scanning technologies such as bar codes, QR codes or RFID chips inserted into the packages may include product information that can be scanned and transmitted to the IOIT server 110. Any unique way to tag and identify a product/product including technologies like augmented reality or alternate reality headsets may be used to transmit information regarding the products the user intends to purchase.

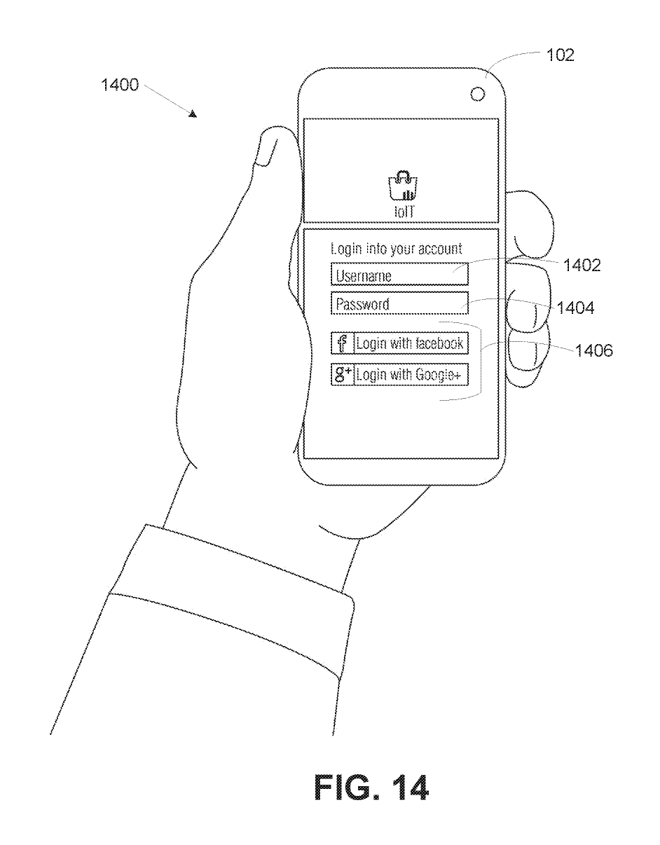

FIG. 14 shows an illustration of a login page 1400 to the IOIT UI 150 displayed the user device 102. The IOIT UI 150 can be provided as a mobile app or a web user interface. Access to the IOIT server 110 services can be provided either via a direct log in wherein the IOIT server 110 provides a user name 1402 and password 1404 or via logging in through credentials from third parties 1406 such as social networks like FACEBOOK or GOOGLE+.

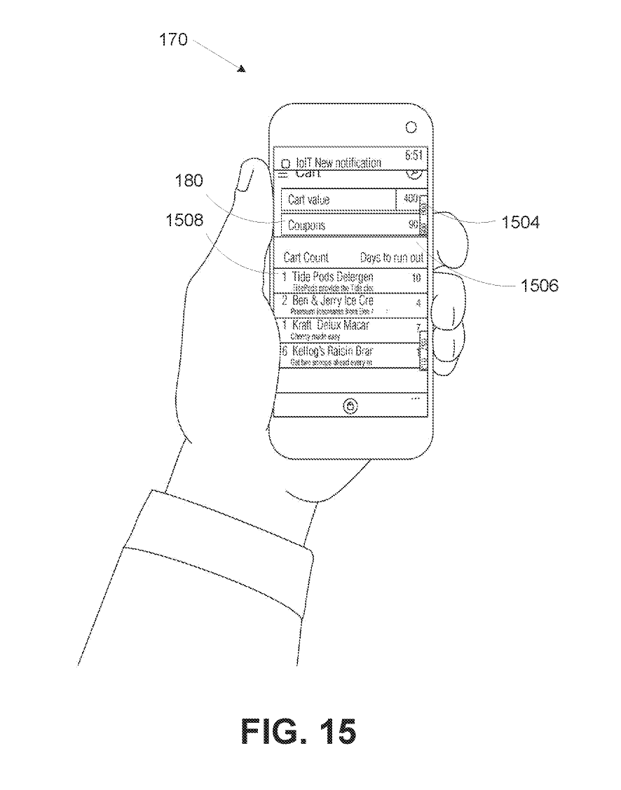

FIG. 15 is an illustration of the shopping list 170 showing dynamic coupons 180 whose values may be updated in response to the user's interactions with the IOIT platform 100. In an example, components of the user device 102 such as the GPS, may be used to sense that the user is in a retail outlet and the dynamic coupons 180 may be updated to reflect the retailers and the brands discounts current offers/discounts for the products in the shopping list 170. The shopping list 170 includes certain staple products 1508 which are periodically replenished by the user along with the number of days the supplies are projected to last 1506. In addition to showing the products, the shopping list 170 also displays the total retail value 1504 of the products added to the shopping cart. The user may be encouraged to complete the purchase transactions if the by comparing the values of the products in the shopping list 170 versus the dynamic coupons 180. In an example, the value of the dynamic coupons 180 may be automatically applied, via transmission of the user's coupon information to the retailer, as the products from the shopping cart 1304 are scanned at the point of sale.

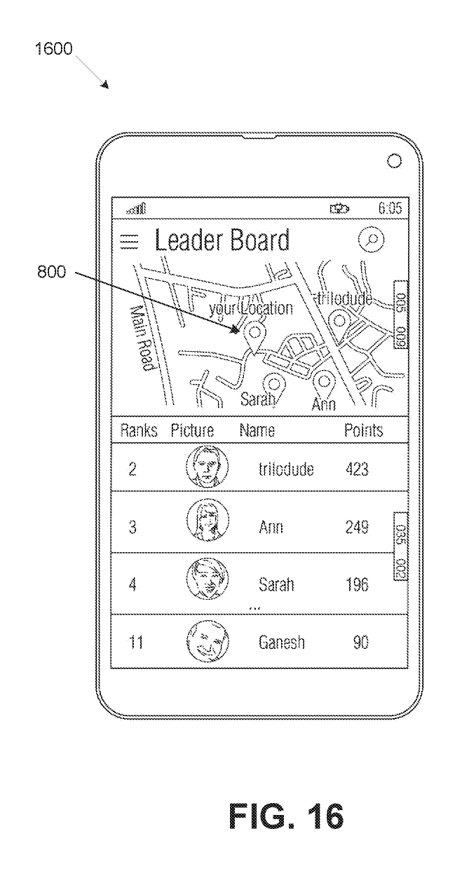

FIG. 16 shows an illustration of a leader board 1600 in the IOIT UI 150. Gamification concepts are implemented by the IOIT platform 100 wherein values of coupons, discounts or offers provided to the users may be dependent on the user participation in the various activities and interactions associated with the IOIT platform 100. In an example, APIs such as PlayLyfe can be used to implement gamification on the IOIT platform 100. Each user interaction carries a certain points which may translate into coupons. The coupon values may be dependent on a fixed component pertaining to buying/selling sessions and a variable component that includes the user's existing points, engagement and stickiness.

The IOIT platform 100 supports numerous chat groups or discussion boards started by the IOIT platform 100 administrator or users. Users may either explicitly select their chat groups or the users may be inducted into automatically selected chat groups. The automatic selection of chat groups for users may be based on the products they purchase, brands they shop for, retailers they use, sentiments they express towards specific products or concepts and other attributes such as but not limited to geographic, demographic and the like. The user groups may include chat bots as their members wherein a chat bot member can post replies to user queries that it detects on the chat board. A user may chat either with other people masked in their avatars or with conversation bots.

A leader board displays members based on their points accumulated from the activities on the IOIT platform 100. In an example, the members may be arranged in a descending order of their accumulated points on a leader board display. In some examples, the IOIT platform 100 may include one leader board for all the users. In other examples, IOIT platform 100 may include one leader board for a group of users, based for example, on criteria such as the users being members of a particular chat group, belonging to a particular geographical location or being members or a particular demographic group and the like. In the various leader boards, a user's position may be determined based on the total points accumulated by the user via interactions with the IOIT platform 100.

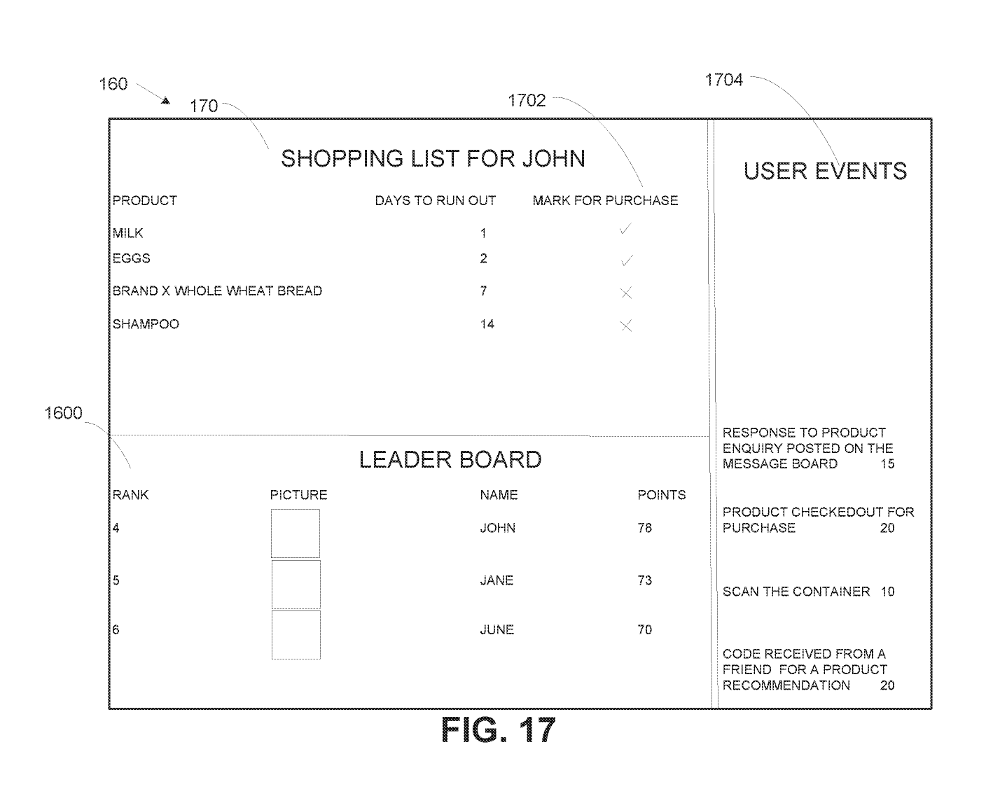

FIG. 17 is a schematic diagram that shows the details displayed in a user profile 160 of the IOIT platform 100. The user profile 160 may provide different views based on the user device employed for logging into the IOIT server 110. The user profile 160 includes the shopping list 170 that is dynamically put together based on the scan data received from the user, push notifications received from the smart appliances 142, 144 and projected dates for replenishment of staple products routinely purchased by the user as determined by the product monitor 128. The shopping list 170 not only displays the days until the supplies last, but provides the user an opportunity to determine if a product should be marked for purchase 1702. Those products marked for purchase may be moved up the shopping list 170. A leader board 1600 of the IOIT platform 100 showing the user's position in comparison with other members of the IOIT platform 100 may also be displayed within the user profile 160. In addition to the shopping list 170 and the leader board 1600, the user profile 160 may also display user events or user interactions 1704 that contribute to the user's points on the IOIT platform 100 and how many points each of the user interactions 1704 contributed to the overall points tally.

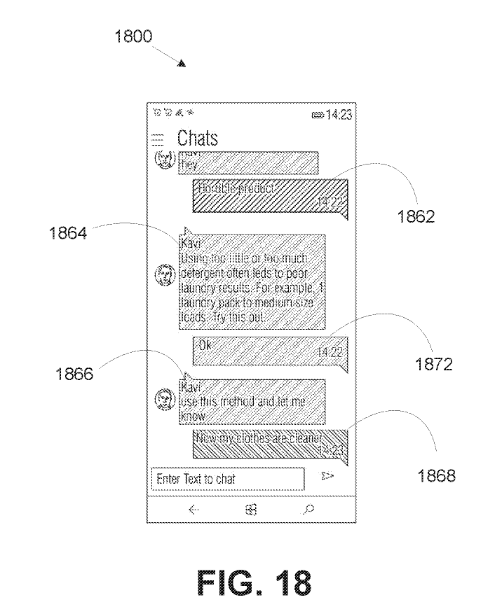

FIG. 18 shows a view 1800 of a chat group wherein different messages are posted by the users of the chat group displayed on backgrounds indicative of the sentiments expressed in the message. The analysis of the sentiment expressed within a comment occurs prior to posting the comment on the message board. A user reviewing the chat board, may, at a glance decide which comments to review. For example, the user who is assessing the product for purchase may want to review the negative comments initially before reviewing the neutral or positive comments that may provide solutions to the complaints made in the negative comments. Therefore, message 1862 which expresses a negative sentiment may be displayed on a red background while the message 1868 which expresses a positive sentiment may be displayed on a green background. Neutral messages may be displayed on different background colors based on whether or not they are informative. Messages 1864 and 1866 that do not express any sentiments but convey facts or solutions to complaints are displayed on a distinct yellow background to enable a reviewing user to quickly identify facts or solutions within the message flow. Messages such as 1872 which are neutral and not informative such as ‘OK’, may be displayed on yet another background color such as, grey. The IOIT server 110 may implement Al procedures wherein trained classifiers can be used to separate neutral, non-informative messages from neutral, informative messages for display on different background colors.

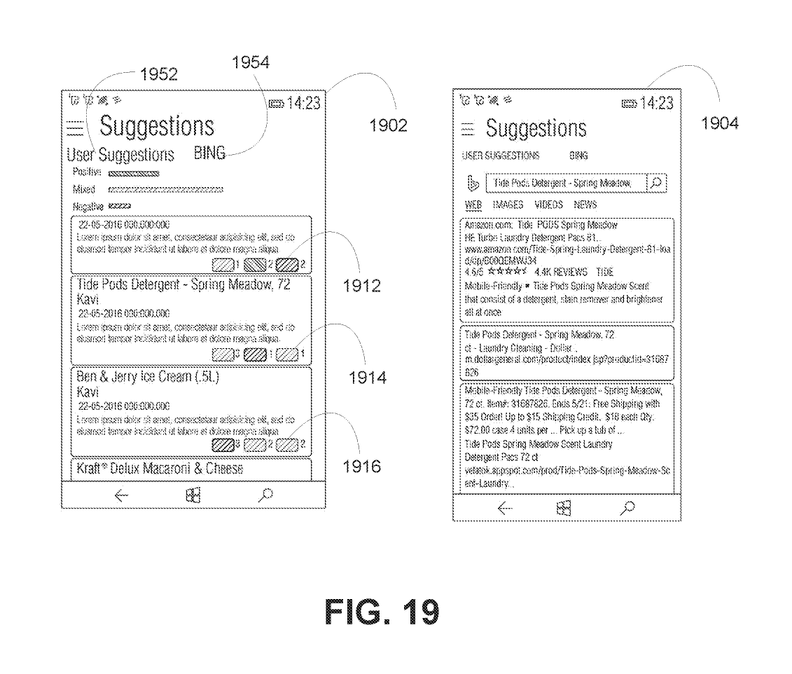

FIG. 19 shows search results provided by the IOIT platform 100 in response to a user query. The IOIT platform 100 provides results from within the chat groups on the IOIT server in addition to results from conducting an internet search. In an example, the IOIT platform may interface with a search engine and the query from the user is submitted to the search engine. The results from the user suggestions and the search engine may be displayed under respective tabs 1952 and 1954. The user suggestions from the message boards are shown in the display 1902 with legends that show the sentiments expressed in the suggestions. For example, the result 1912 includes two comments expressing negative sentiments. The result at 1914 includes a neutral, informative comment while the result at 1916 includes two comments expressing a positive sentiment. Based on the sentiments expressed, the user may select one of the results 1912, 1914 or 1916 for further review. When the tab 1954 is selected, a view similar to the display 1904 including the internet search results is shown to the user.

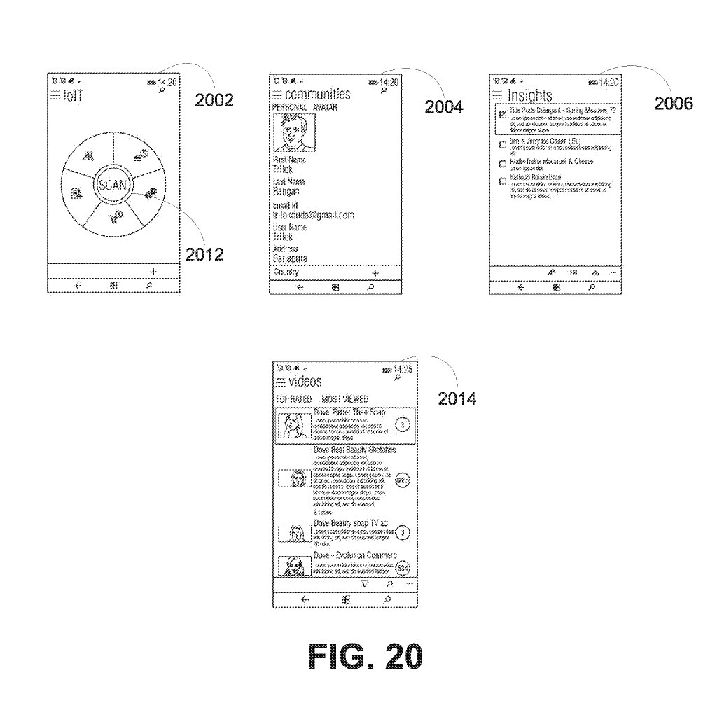

FIG. 20 shows various views that may be generated by the IOIT UI 150 in accordance with some examples. A central home page 2002 may be displayed upon successful login by the user from the login page 1400. The central home page 2002 via which various activities such as shopping cart, chat groups, leader board and the like associated with the IOIT platform may be accessed. A scan button 2012 allows the user to scan codes on the containers for products that the user wishes to use in the interactions such as, adding to the shopping list 170, conducting a search, posting a feedback and the like with the IOIT platform 100. At 2004 a user profile view having the user details or attributes is shown. At 2006 a shopping list with the details of various products therein is shown. The view at 2014 shows a number of videos that may be retrieved and shown to users on the IOIT platform 100 in response to a single-select or multi-select query.

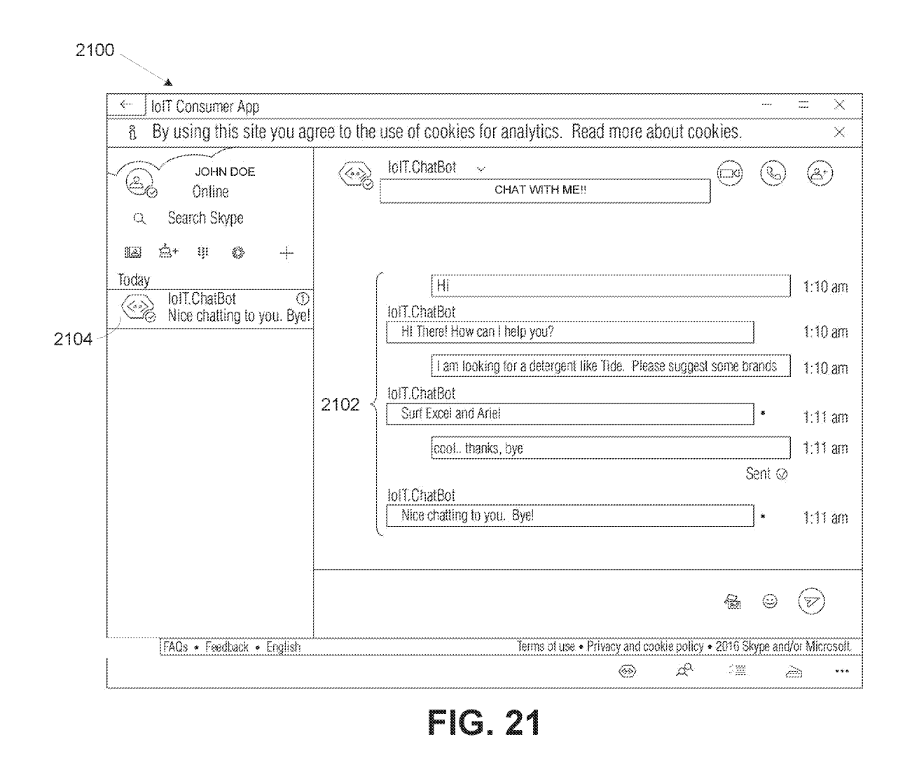

FIG. 21 shows a chat window 2100 wherein a user is in conversation 2102 with a chat bot named IOIT.ChatBot 2104. The IOIT sever 110 may support multiple chat bots that can conduct conversation with end users in specific topics related to the IOIT platform 100 such as but not limited to products, market, consumers and the like. The conversation with chat bots enables the user to exchange not only instant messages but also images, videos or other multi-media content via a messaging platform such as SKYPE. The chat bots that users converse with may have access to the users' user names on the messaging platform, the text messages and multimedia content that was exchanged between the users in the chat group. The chat bot 2102 replies to the user's query regarding detergents in the market. Commercially available bot services and API can be used to implement the chat bots on the IOIT platform 100. While text messages are shown and discussed herein, it can be appreciated that voice chats can also be conducted with the chat bots in some examples.

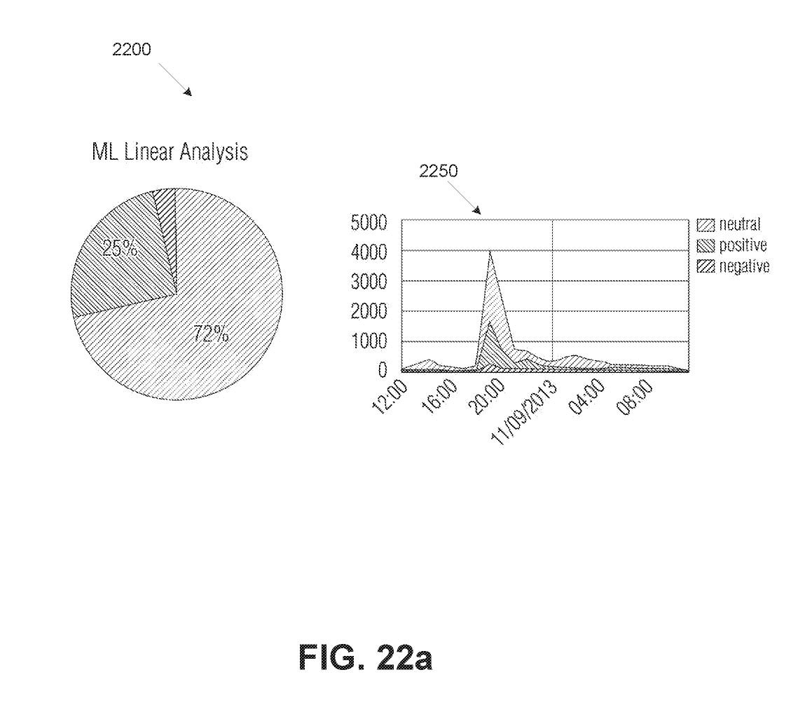

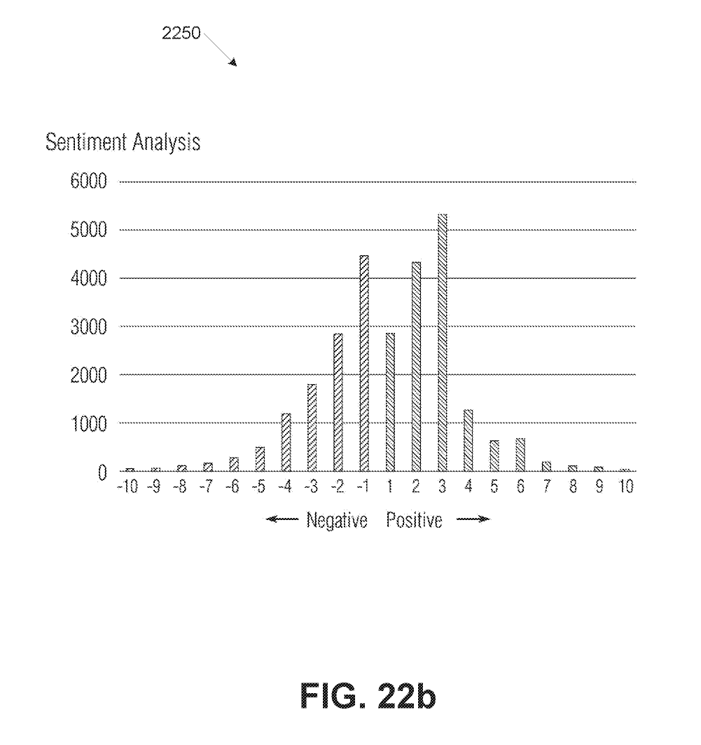

FIG. 22a is a diagram that shows a pie chart 2200 mapping the sentiments expressed in user comments or feedback. FIG. 22b shows a bar graph 2250 mapping sentiments expressed in user comments. The sentiments in messages can be determined via sentiment APIs. In addition to routine purchases of a brand, the user's loyalty to the brand may be determined via text analysis of the user's messages posted in the IOIT UI 150 regarding the brand by normalizing user's text over the word cloud.

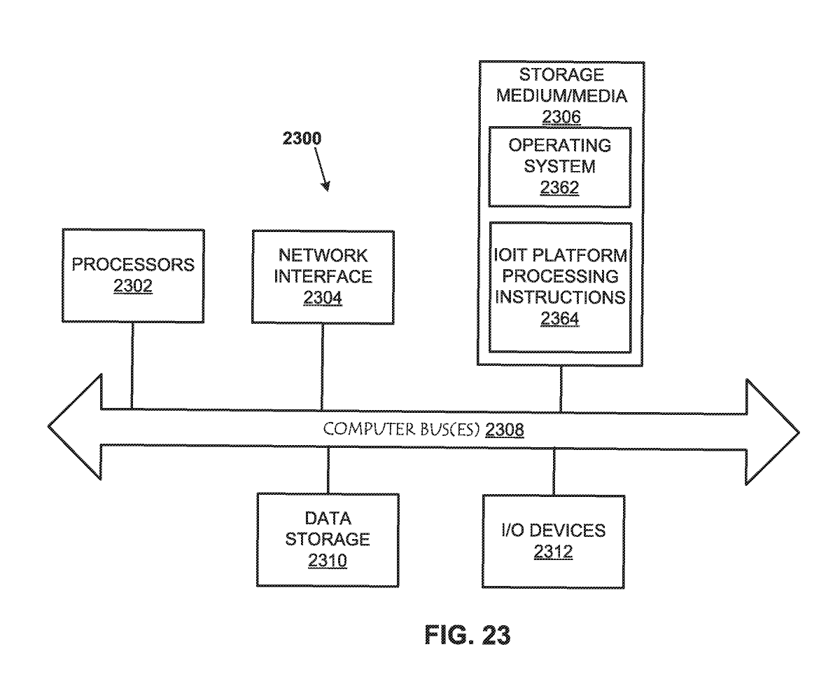

FIG. 23 illustrates a computer system 2300 that may be used to implement one or more of the IOIT server 110, the brand servers 132, 134, the retail servers 124, 126 or a user device. More particularly, computing machines such as desktops, laptops, smartphones, tablets, wearables which may be used to record, transmit, compute values for and receive dynamic coupons may have the structure of the computer system 2300. The computer system 2300 may include additional components not shown and that some of the components described may be removed and/or modified.

The computer system 2300 includes processor(s) 2302, such as a central processing unit, ASIC or other type of processing circuit, input/output devices 2312, such as a display, mouse keyboard, etc., a network interface 2304, such as a Local Area Network (LAN), a wireless LAN, a 3G or 4G mobile WAN or a WiMax WAN, and a computer-readable medium 2306. Each of these components may be operatively coupled to a bus 2308. The computer readable medium 2306 may be any suitable medium which participates in providing instructions to the processor(s) 2302 for execution. For example, the computer readable medium 2306 may be non-transitory or non-volatile medium, such as a magnetic disk or solid-state non-volatile memory or volatile medium such as RAM. The instructions or modules stored on the computer readable medium 2306 may include machine readable instructions 2364 executed by the processor(s) 2302 to perform the methods and functions for the IOIT platform 100 as detailed herein. The computer readable medium 2306 may also store an operating system 2362, such as MAC OS, MS WINDOWS, UNIX, or LINUX. The operating system 2362 may be multi-user, multiprocessing, multitasking, multithreading, real-time and the like. For example, during runtime, the operating system 2362 is running and the instructions 2364 are executed by the processor(s) 2302.

The computer system 2300 may include a data storage 2310, which may include non-volatile data storage. The data storage 2310 stores any data used by the VR content processing and management systems. The data storage 2310 may be used to store events, coupon information transmitted by the brands and retailers, user feedback information, business analytics and the like.

The network interface 2304 connects the computer system 2300 to internal systems for example, via a LAN. Also, the network interface 2304 may connect the computer system 2300 to the Internet. For example, the computer system 2300 may connect to web browsers and other external applications and systems via the network interface 2304.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims, and their equivalents, in which all terms are meant in their broadest reasonable sense unless otherwise indicated.

What is claimed is:

1. A network system for monitoring appliances comprising:
at least one processor; and
a non-transitory data storage storing machine readable instructions that cause the at least one processor to:
receive scanned data identifying at least one product of interest to a user;
access a mapping of the scanned data to one or more keywords used to identify the product;
determine one or more actions to be performed in response to the receipt of the scanned data, the one or more actions comprising, a replenishment, an enquiry and a feedback process;
if the one or more actions comprise the replenishment:
determine if the product of interest is included in a profile of the user;
if the product is not included in the user profile:
add the product to the user profile for recurring use, the addition of product comprising receiving data identifying appliances to be monitored for supplies of the product;
if the product is included in the user profile:
add the product to a shopping list as an intended purchase;
if the one or more actions comprise feedback regarding the product:
receive comments from the user as the feedback for the product;
derive a sentiment expressed in the comments;
provide a background color for the comments based on the sentiment that was derived; and
post the comments with the background color for display in conversations in relevant user groups;
if the one or more actions comprise request for information:
conduct a search for information regarding the product of interest, the search comprising an Internet search and a search of one or more user group conversations using the keywords; and
transmit results of the search for display to a device associated with the user, the results from the user group conversations being displayed with sentiment information.

2. The network system of claim 1, the instructions for determining if the product is included in the user profile further comprising instructions that cause the processor to:
determine if the keywords match one or more existing keywords comprised in the user profile.

3. The network system of claim 2, the instructions for adding the product to the user profile for recurring use further comprising instructions that cause the processor to:
collect data regarding the user's usage of the product over time;
project a date when the product is to be exhausted and due for the replenishment based on the usage data of the user; and
transmit the date for display on a user interface within a threshold time period of the date.

4. The network system of claim 3, the instructions for collect data regarding the user's usage of the product further comprising instructions that cause the processor to:
collect data from the monitored appliances regarding amount of supplies of the product over the time.

5. The network system of claim 1, the instructions for dynamically deriving a sentiment associated with the comments further comprising instructions that cause the processor to:
parse the comments;
identify from the comments, words that are indicative of the user's sentiments; and
analyze word clouds in view of the words using sentiment APIs (Application Programming Interfaces); and
derive the sentiment from a plurality of sentiments upon the analysis of the respective word clouds.

6. The network system of claim 5, the instructions for post the comments with the background color for display further comprising instructions that cause the processor to:
transmit the comments for display with the background color selected from a plurality of background colors, each of the plurality of background colors corresponds to one of a positive, negative and neutral sentiment.

7. The network system of claim 1, the instructions for transmitting the results of the search for display further comprising instructions that cause the processor to:
further determine if the request for information was received in a conversation with a chat bot; and
transmitting the information from the search to a messaging app associated with the chat bot.

8. The network system of claim 1, the instructions for adding the product to a shopping list as an intended purchase further comprising instructions that cause the processor to:
determine dynamically, coupon values to be applied to the intended purchase.

9. The network system of claim 8, further comprising instructions that cause the processor to:
apply the coupon values to transactions associated with the product at a time of purchase.

10. The network system of claim 1, wherein the at least one product comprises a plurality of products.

11. The network system of claim 10, the instructions for conducting a search for information regarding the product of interest, further comprising instructions that cause the processor to:
conduct the search for information with the keywords associated with the plurality of products.

12. A method of monitoring appliances comprising:
receiving from a user, data identifying appliances to be monitored for supplies;
storing, in a profile of the user comprised in a server, the data identifying the appliances to be monitored;
receiving from the appliances, push notifications when supplies of respective products within each of the appliances go below respective predetermined thresholds;
automatically moving the products up to a top of a shopping list comprised in the user profile in response to receiving the push notifications;
marking the products moved to the top of the shopping list for purchase by the user;
identifying one or more coupons available for application to the products marked for purchase by the user;
determining a number of points available to the user from interactions of the user with the server, the interactions comprising purchase of products, posting comments, making enquires, configuring additional appliances to send push notifications, using available coupons and points;
receiving scan data from containers of the products in the shopping list that the user selected for purchase;
generating a combined value associated with the one or more coupons and the number of points for application to the purchase of the products prior to a purchase transaction; and
enabling application of the combined value to the purchase transaction.

13. The method of claim 12, further comprising:
storing data regarding purchases of the products in the user profile; and
detecting trends in the purchase data of the products.

14. The method of claim 13, further comprising:
projecting based on the trends, respective dates when each of the products are likely to be exhausted; and
displaying the respective dates on a user device associated with the user.

15. The method of claim 12 wherein receiving push notifications from the appliances, further comprises:
receiving from one of the appliances, the push notifications when weight of one of the products stored in the appliance is below a predetermined weight threshold, wherein the appliance includes a weight sensor.

16. The method of claim 12 wherein configuring the appliances to send push notifications to the server further comprises:
receiving from one of the appliances, the push notifications when level of one of the products stored in the appliance is below a predetermined level threshold, wherein the appliance includes a level sensor.

17. The method of claim 12, wherein configuring the appliances to send push notifications to the server further comprises:
receiving from one of the appliances, the push notifications when one of the products comprised in the appliance malfunctions.

18. A non-transitory computer-readable storage medium comprised in a user device, the computer-readable storage medium comprising machine-readable instructions that cause a processor to:
display a user interface that enables a user to scan at least one product code and execute one or more actions associated with the at least one product code, the one or more actions comprising a replenishment of a product identified by the at least one product code, an enquiry associated with the product and a feedback regarding the product;
transmit the product code to a network server;
if the one or more actions comprise the replenishment, then:
display the product at a beginning of a shopping list if the product already exists in a user profile associated with the user device;
add the product to the user profile for recurring use if the product is not included in the user profile;
display the product at the top of the shopping list; and
receive data regarding appliances to be monitored for supplies of the product;
if the one or more actions comprise feedback regarding the product:
receive comments from the user as the feedback for the product;
transmit the comments to the server for posting in relevant user groups; and
display the comments with a background color in conversations in the relevant user groups, the background color being indicative of a sentiment expressed in the comments;
if the one or more actions comprise request for information:
display results of the search to the user, the results comprising results from an internet search and results from conversations in a plurality of user groups, the results from the user group conversations being displayed with sentiment information.

19. The computer-readable storage medium of claim 18, wherein instructions for displaying results of the search to the user, further comprise instructions that cause the processor to:
display each of the results from the user group conversations with a legend showing number of comments associated with each of a positive, negative and neutral sentiments.

20. The computer-readable storage medium of claim 18, wherein instructions for:
sensing that the user is located at a retail outlet;
transmitting the user's location to the network server; and
updating values of coupons associated with the user's profile prior to the user completing purchase transaction for the product in the shopping list.
